(19) United States
(12) Patent Application Publication
(10) Pub. No.: US 2008/0288443 A1
(43) Pub. Date: Nov. 20, 2008

(54) Customizable Joint Type Assignment Method And Apparatus

(76) Inventor: William P. Darbie, Fort Collins, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/749,223

(22) Filed: May 16, 2007

(51) Int. Cl. G06F 17/30; G06F 17/50

(52) U.S. Cl. 707/2; 703/1; 707/102; 707/E17.005; 707/E17.031

(57) ABSTRACT

Application software in a tester for generating and running test programs for testing a printed circuit board is presented. The application software may include customizable joint type assignments from a CAD file making use of regular expressions.

### BACKGROUND

The present invention is generally related to systems and methods for a user to create rules to build a dictionary or mapping table using regular expressions.

Currently, a variety of systems and processes are used for inspecting manufacturing defects in printed circuit boards. Printed circuit boards typically include one or more electrical components (e.g., computer chips, capacitors, resistors, inductors, etc.) soldered to a printed circuit board. For many years, the de facto process for production of printed circuit board assemblies included manual visual inspection (MVI) after soldering, followed by an electrical test, such as in-circuit testing (ICT), at the end of the assembly process to isolate any defects that occurred during manufacturing. Typically, a final functional test was run to verify that the printed circuit board operated properly before it was integrated into a final product.

As the need for more complex printed circuit boards having more components increased, automated inspection systems became popular. Such inspection systems typically comprise a printed circuit board modeling system, an imaging system, and a control system. Typically, the modeling system is used to generate a computer model of a printed circuit board that is to be mass-produced. The modeling system may be a computer aided drafting (CAD) system. The imaging system may comprise hardware and software for capturing an image of the manufactured printed circuit board being tested. Currently, image systems employ a variety of imaging techniques (e.g., x-ray, optical, ultrasonic, thermal image, etc.). The control system typically receives a file or files containing the computer model of the particular printed circuit board from the modeling system.

Based on the computer model, the control system may generate an inspection program to be implemented by the imaging system. The inspection program may be used to image a manufactured printed circuit board (PCB), which is based on the computer model generated by the modeling system. After the imaging system generates the images of the manufactured printed circuit board, the images may be analyzed to inspect for a variety of manufacturing defects (e.g., open solder joints, shorts, missing components, misaligned components, insufficient solder joints, excess solder joints, reversed capacitors, solder balls, solder voids, etc.).

Control systems implemented in current PCB inspection systems typically employ a graphical user interface to assist in generating the inspection program to be implemented by the imaging system and for interfacing with the PCB modeling system. Current graphical user interfaces are rather difficult to use, have non-customizable rules to determine joint types of a components package (which are used to determine which classification algorithm to use to inspect a solder joint) and usually require the user to manually change the inspection program, if it doesn't meet their requirements for one reason or another or if the non-customizable rules were inadequate. For example, a rule may state that any component name starting with a “C” is a capacitor joint type. If this is not true for a particular customer's PCB CAD design, than the customer would have to go into the program and manually fix any problems this rule created in their inspection program. Test developers have spent many hours tuning a test program to get the right joint type designation where non-customizable rules have been inadequate for their printed circuit boards and CAD or computer model.

Thus, there is a need for a customizable joint type assignment.

### BRIEF DESCRIPTION OF THE DRAWINGS

An understanding of the present teachings can be gained from the following detailed description, taken in conjunction with the accompanying drawings of which like reference numerals in different drawings refer to the same or similar elements.

FIG. 1 illustrates a screen shot of an embodiment of a graphical user interface in which a customizable joint type assignment from CAD making use of regular expressions may be implemented.

FIG. 2 illustrates a screen shot of an embodiment of the graphical user interface in which a joint type assignment rule set and a CAD data file to be imported may be selected.

FIG. 3 is a flow chart illustrating the architecture, operation, and/or functionality of tester application software with a graphical user interface and user customizable joint type assignments from CAD making use of regular expressions.

### DETAILED DESCRIPTION

In the following detailed description, for purposes of explanation and not limitation, example embodiments disclosing specific details are set forth in order to provide an understanding of embodiments according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatus and methods may be omitted so as to not obscure the description of the example embodiments. Such methods and apparatus are clearly within the scope of the present teachings.

A method for a user to customize rules in order to generate a new field of data from one or more existing fields of data. This could apply to any number of things, including any database of any kind of information. A specific instance of this is in the case of x-ray tester software, where CAD information describing a printed circuit board is incomplete. Typical CAD does not describe component package information. But for x-ray testers, it is desirable to have package information, specifically what type of joint does a components package have (BGA, through hole, Gullwing, JLead, etc). This information is used so the x-ray software knows which classification algorithm to use to determine if the solder on a particular joint is good or bad. From the CAD that is available, the joint type of a package can be inferred, even though it is not directly specified in the originally CAD data. So for an x-ray tester application, this invention allows the user to configure rules that determine how to infer new data (joint types of component packages) from several other pieces of data (a components reference designator, a components land pattern name, the location and number of pads a component has, where pin one is located on the component, etc) that exist in the CAD description of the printed circuit board that will be tested. Our application uses a GUI to allow the user to select and customize these rules. However, a text file or some other implementation could have been used as well.

One or more CAD data files, describing a particular printed circuit board layout with location and types of parts on the printed circuit board, are imported by the tester software. These CAD data files are translated into a format that the tester software can understand. Since this data is incomplete, missing data needs to be determined. One specific case of this is the missing component package joint type. The customizable rules that the user selected are used to determine this missing joint type data. From the original CAD data and the joint type information determined by the customizable rules, an inspection program can be generated. Tests may than be run on the printed circuit board and the results displayed by the test system software.

In the present invention, the end user may customize the rules, turn the rules on and off, modify the rules or add to the rules list. The rules use regular expressions in order to optimize flexibility. Regular expressions are well known in the field of computing. In the present invention, the rules assign joint types. Joint types are mapped to classification algorithms by the test development software. The software looks at the translated CAD data files coming in and applies a set of rules to determine the missing component package joint type. This process is done per joint. The rules look at things such as: number of pads on the component; number of rows of pads on the component; number of columns of pads on the component; where pin 1 is located on the component; the reference designator of the component; and the land pattern name of the component.

The tester software extracts data from several fields of data (i.e., the translated CAD files) and produces a new field of information to associate with each record, based on conclusions inferred from the information in the original fields of data and the proper interpretation from the user or test developer captured in the form of rules. For example, the user or test developer may create a rule such as, if the prefix of a component is “C” and the number after the “C” is >=55 and <=121, than the component is a PCap. Thus, when the test program is developed, when a component named “C101” is encountered, the program will treat the component as a PCap.

By way of further example, if a test developer had a data base or CAD file of component locators on a printed circuit board and wanted to apply a different test to each component based on its type, the test developer may build a rule dictionary such as: Pin=Appled joint type; U16PIN1=Gullwing joint type; U18pin 5=JLead joint type; U55pin 8=BGA joint type; C12=Cap joint type; CP pin 6=Std coupler joint type; C101 pin1=Polarized Capacitor joint type; etc.

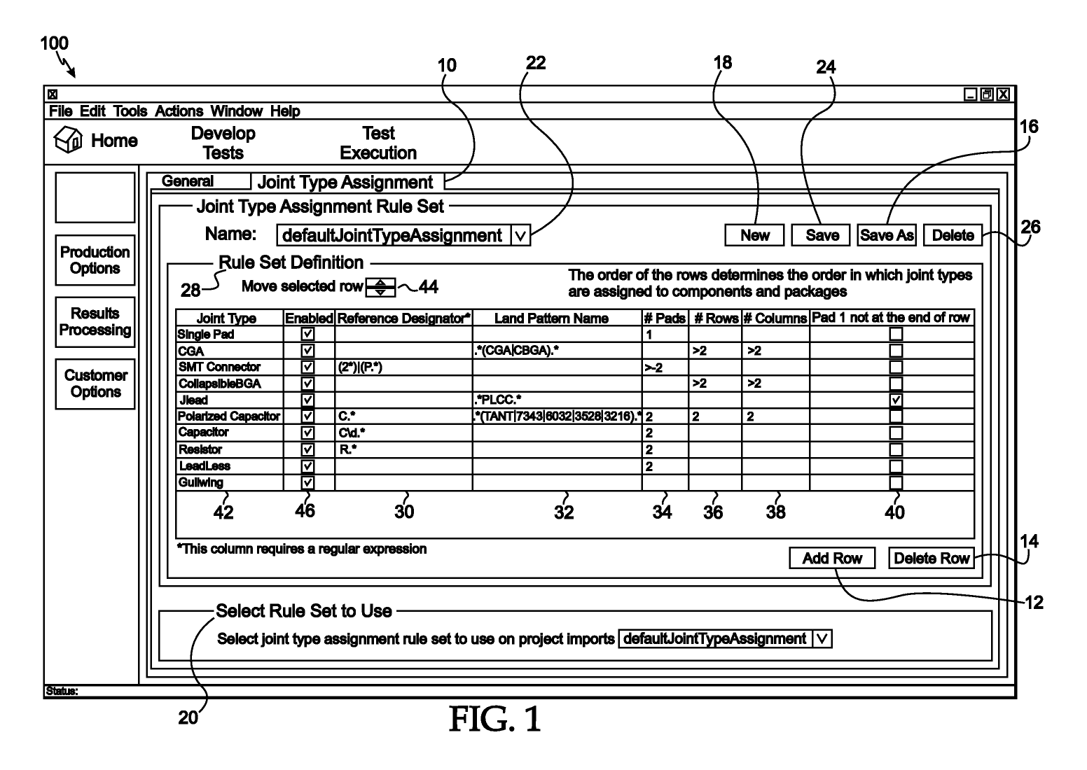

FIG. 1 illustrates a screen shot of an embodiment of a graphical user interface in which a customizable joint type assignment from CAD making use of regular expressions may be implemented. The system configuration options under the joint type assignment tab 10 include joint type assignment rules/rules definition 28 and Select Rule Set to Use 20. The test developer or user will select the correct Joint Type Assignment rule set in the Select Joint Type Assignment rule set to use on project import box 20. The Joint type Rule set name showing in the box is the one that will be used in production testing.

The Joint Type Assignment Rules panel 100 acts as an independent document. Once the user modifies this panel, the information can be saved 24 as a separate rule set. This can be done multiple times as long as a unique name in the Name drop box 22 is given to each joint type assignment rule set. The joint type assignment default rule set may not be modified itself, but may be modified and saved as under a new name.

The Reference Designator column 30 uses regular expressions. The user may enter a pattern to match the joint's component name, such as “C.*” equals a polarized capacitor; “R.*” equals a resistor; “C\d.*” equals a capacitor; etc.

The Land Pattern Name column 32 uses regular expressions. The user may enter a pattern to match the joint's land pattern name, such as “*(CGA|CBGA).* equals a CGA; *PLCC.* equals a Jlead package; etc.

The #Pads column 34 identifies the number of pads of the component for the rule, such as 1; 2; >=2, etc. The user may enter a whole number; <number; > number; <=number; >=number, etc.

The #Rows column 36 identifies the number of rows of pads of the component for the rule, such as 1; 2; >=2, etc. The user may enter a whole number; <number;> number; <=number; >=number, etc.

The #Columns 38 identifies the number of columns of pads in the land pattern for the component for the rule, such as 1; 2; >=2, etc. The user may enter a whole number; <number;> number; <=number; >=number, etc.

The Pad1 not at the end of row column 40 may be selected if Pad 1 of the component does not fall at the end of the row.

Rows may be added or deleted with Add Row 12 and Delete Row 14 buttons.

In the Select Joint Type Assignment rule set to use on project import box 20, the user may identify the rule set name for the joint type assignment rule set that is to be used when a project is imported from the CAD data files.

The joint type assignment rules panel 100 and the rules definition panel 28 are used to define joint type assignments. A specific set of conditions is assigned to each joint type 42 indicated in the table. If all the conditions are met, the joint type specified in the row will be assigned. The order of the rows may determine the order in which the joint types are assigned to components and packages. Data in columns may be AND-ed together for each row. The last row in the rule definition table may be setup to catch any remaining joints that did not match the rules in the above rows.

If at least one condition is not met, the program will move to the next row. The table may contain a catch all rule as the last row in the table. This can be a row with no conditions in any of the columns. If one is not found, an empty Gullwing ‘catch-all’ rule may automatically be added to the rule set. This means that if none of the rows' conditions are met for a joint, it will be assigned the joint type Gullwing.

The default rule set DefaultJointTypeAssignment 22 contains default joint type assignment settings for the system. If any rules are modified, the rule set may be saved with a different name using the Save As button 16. Preferably, the rule set DefaultJointTypeAssignment may not be edited. To begin with a blank rules definition table 28, the user or test developer may click the New button 18.

Rows in the joint type assignment table may be moved up or down with the move selected row button 44. The user or test developer may select the row to be moved and click on the up or down arrow to move the row accordingly.

The end user or test developer may indicate in the joint type column 42 the joint type the rule will apply to. The end user may right click on this box to activate a drop down box (not shown) with all of the joint names listed. Multiple rows with the same joint type selected may be possible.

The end user or test developer may select the enabled box 46 to enable the rule for a particular row. The box may be disabled for a particular row by clearing the box. A disabled rule will be ignored by the program.

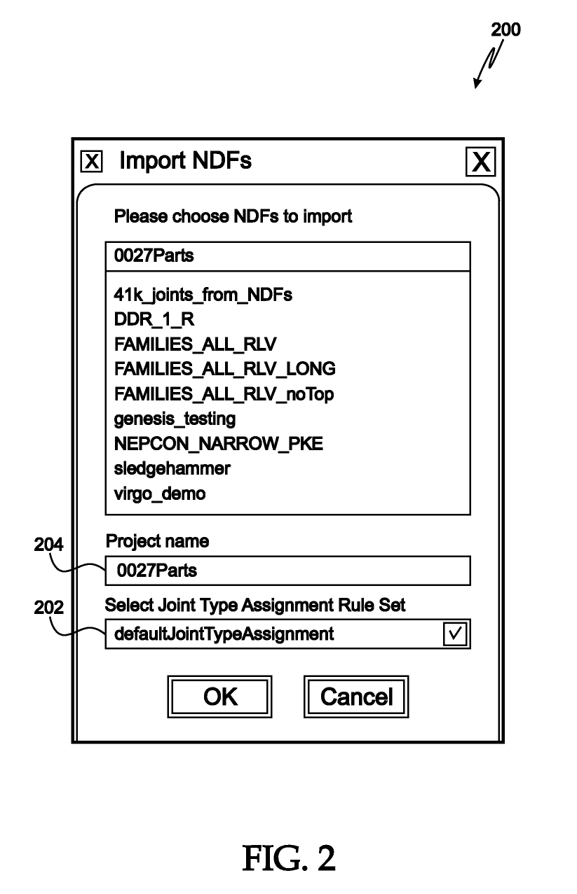

The joint type assignment rule set that is in use 202 can be seen at the bottom of the Import CAD dialog box 200 in the test development environment, see FIG. 2. The Import CAD dialog box is brought up when the user or test developer clicks “Import” on the File menu in the test development environment. In the Import CAD dialog box, the user may select which set of rules to apply 202 and the CAD or project name to import 204. The user may then click the “OK” button. The test software will then import the selected CAD files, translate them into a language understandable by the tester software, and assign joint types using the joint type assignment rule set selected.

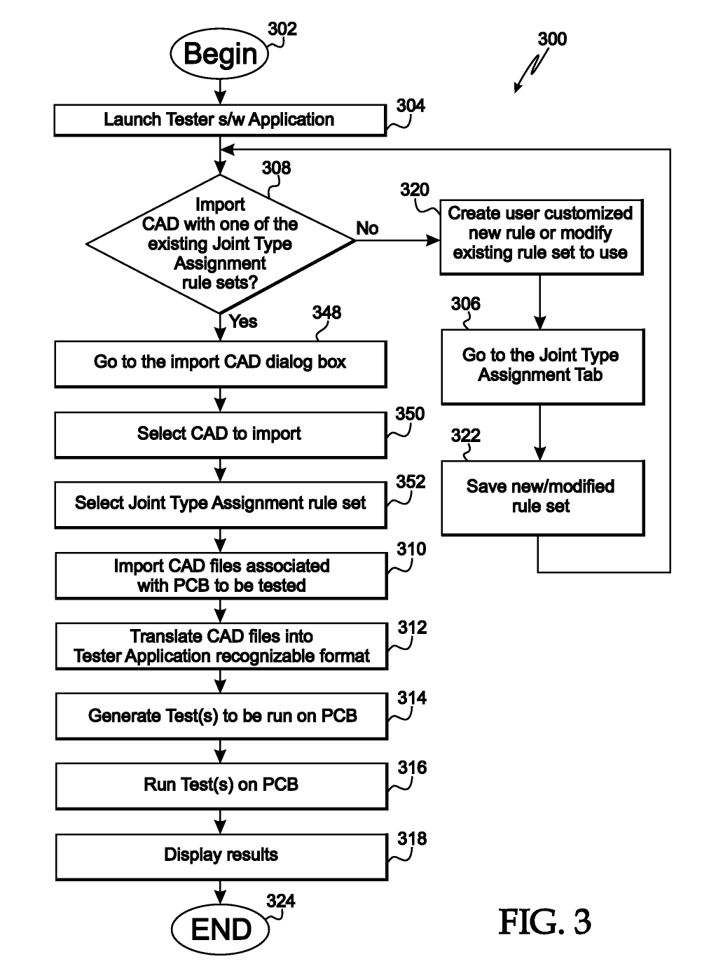

FIG. 3 shows a flow chart illustrating the architecture, operation, and/or functionality of tester application software with a graphical user interface and user customizable joint type assignments from CAD making use of regular expressions. After the tester software application is launched 304, the test developer may go to the import CAD dialog 348. From there the test developer may select which CAD to import 350. They also may select which joint type assignment rule set to use from the list of rule sets that have been defined already 352. Then, the CAD files associated with the printed circuit board to be tested may be imported 310 and translated into a tester software application recognizable format 312. Next, test(s) to be run on the printed circuit board may be generated 314 and test may be run on the printed circuit board by the tester 316. Finally, the test results may be displayed 318. If the test developer wants to modify or create a new rule set 320, the developer may go to the joint type assignment tab 306. Once the rule set is created or modified the test developer may save the rule set 322.

Embodiments of the teachings are described herein by way of example with reference to the accompanying drawings describing a customizable joint type assignment from CAD making use of regular expressions. Other variations, adaptations, and embodiments of the present teachings will occur to those of ordinary skill in the art given benefit of the present teachings.

1. A computer program embodied in a computer-readable medium, the computer program comprising logic configured to:
receive user defined rules that map a new field of data from one or more existing fields of data;
receive one or more existing fields of data; and
generate a new field of data by mapping the one or more fields of data to the user defined rules.

2. The computer program of claim 1, wherein the computer program comprises an x-ray tester application.

3. The computer program of claim 1, wherein the computer program comprises a graphical user interface.

4. The computer program of claim 2, wherein the one or more existing fields of data comprises CAD data files of a printed circuit board layout.

5. The computer program of claim 1, wherein the new field of data is generated using regular expressions.

6. The computer program of claim 1, wherein the user defined rules use regular expressions.

7. The computer program of claim 4, wherein the logic is further configured to run x-ray tests on a printed circuit board associated with the CAD data files.

8. The computer program of claim 7, wherein the new field of data generated is used to generate one or more test programs to be run on one or more printed circuit boards represented by the CAD data files.

9. A computer program embodied in a computer-readable medium, the computer program comprising logic configured to:
receive user defined rules using regular expressions that map a new field of data from one or more existing CAD data files;
receive one or more existing CAD data files; and
generate a new field of data by mapping the one or more CAD files to the user defined rules.

10. The computer program of claim 9, wherein the computer program comprises an X-ray tester application.

11. The computer program of claim 10, wherein the new filed of data generated is used to generate one or more test programs to be run on one or more printed circuit boards represented by the CAD data files.

12. A method comprising:
launching an x-ray tester application software program;
selecting joint type assignment tab;
mapping user defined rules to one or more CAD data files representing a printed circuit board to be tested;
saving user defined rules;
importing CAD files representing the printed circuit board to be tested;
translating imported CAD files to x-ray tester application recognizable format;
generating one or more tests to run on printed circuit board to be tested; and
running one or more tests on printed circuit board to be tested.

13. The method of claim 12, further comprising displaying results of one or more tests run on the printed circuit board.
